(19) United States
(12) Patent Application Publication
(10) Pub. No.: US 2023/0217887 A1
(43) Pub. Date: Jul. 13, 2023

(54) LITTER VESSEL ASSEMBLY

(71) Applicant: Deborah M. Loss, Scottsdale, AZ (US)

(72) Inventor: Deborah M. Loss, Scottsdale, AZ (US)

(21) Appl. No.: 17/571,178

(22) Filed: Jan. 7, 2022

(51) Int. Cl. A01K 1/01

(52) U.S. Cl. CPC A01K 1/011

(57) ABSTRACT

A litter vessel assembly includes a vessel including a bottom for reception of broken down litter. The bottom is positioned over a confined volume and is configured with slots and a hatch. The slots are configured to disable unbroken down litter from falling downwardly therethrough into the confined volume from the vessel and enable broken down litter to fall downwardly therethrough into the confined volume from the vessel. The hatch is adjustable between a closed position closing a hatchway to the confined volume and an open position opening the hatchway to the confined volume.

### FIELD OF THE INVENTION

The present invention relates generally to litter upon which an animal can eliminate its bodily waste, namely, feces and urine, and, more particularly, to litter boxes configured to enable broken down litter to pass through openings of a bottom of a litter vessel leaving unbroken down litter behind.

### BACKGROUND OF THE INVENTION

A litter box is a bodily waste repository for cats and other animals that primarily reside indoors. A standard litter box includes a vessel or receptacle charged with a filler or litter, any of various absorbent materials upon which an animal can eliminate its bodily waste, namely, feces and urine. The litter is typically a loose granular or pellet material configured to absorb moisture and odors. Litter soiled by animal's body waste is removed periodically from the clean or unsoiled litter, which is replenished or replaced with fresh litter as needed.

Modern litter generally includes clumping litter and pellet litter, which have replaced the first commercially available non-clumping loose litter typically formed of sand or Fuller's earth clay. Clumping litter, customarily made of granulated bentonite clay, forms solid, easily removable clumps when wet. Biodegradable pellet litter, loose pellets of biodegradable wood, recycled newspaper, corn, wheat, walnuts, barley, soy pulp, or other plant material breaks down into fine particles/powder when wet. Any pellets not wettened remain intact.

Pellet litter is popular and favored among many pet owners. However, it is difficult to separate the fine soiled particles/powder from the unbroken down pellets. While skilled artisans have developed litter box systems configured to separate the broken down pellet litter from the fresh unbroken down pellets, existing systems are not entirely satisfactory, expensive, complex, and difficult to use and clean. Accordingly, continued improvement in the art is evident.

### SUMMARY OF THE INVENTION

According to the invention, a litter vessel assembly includes a vessel including a bottom for reception of broken down litter, the bottom positioned over a confined volume and configured with slots and a hatch. The slots are configured to disable unbroken down litter from falling downwardly therethrough into the confined volume from the vessel and enable broken down litter to fall downwardly therethrough into the confined volume from the vessel. The hatch is adjustable between a closed position closing a hatchway to the confined volume and an open position opening the hatchway to the confined volume. The hatch, a movable part of the bottom, is hinged to pivot between the closed position and the open position relative to a stationary part of the bottom. The hatch is configured with at least one of the slots. The slots are parallel to each other. A detent pair is configured to hold the hatch in the closed position. The first vessel includes a stop configured to disable the hatch from moving beyond the closed position. The detent pair includes a detent element carried by the hatch and a complemental detent element carried by the stop. The vessel further includes a sidewall extending upright from the bottom. The hatch configured to pivot between the closed position and the open position relative to the sidewall. The sidewall includes a sidewall hatchway extending upright from the bottom, and the hatch includes a secondary hatch configured to close the sidewall hatchway when the hatch is in the closed position and open the sidewall hatchway when the hatch is in the open position. The secondary hatch extends from the hatch to handle, and the handle extends outwardly through the sidewall hatchway beyond the sidewall when the hatch is in the closed position.

According to the invention, A litter vessel assembly includes a first vessel including a first bottom for reception of broken down litter, and a second vessel including a second bottom for reception of unbroken down litter and configured with slots and a hatch. The second vessel is nested in the first vessel. The second bottom is elevated at an operative position over the first bottom to form a confined volume between the second bottom and the first bottom. The slots are configured to disable unbroken down litter from falling downwardly therethrough into the confined volume from the second vessel and enable broken down litter to fall downwardly therethrough into the confined volume from the second vessel. The hatch is adjustable between a closed position closing a hatchway to the confined volume and an open position opening the hatchway to the confined volume. The hatch, a movable part of the second bottom, is hinged to pivot between the closed position and the open position relative to a stationary part of the second bottom. The hatch is configured with at least one of the slots. The slots are parallel to each other. A detent pair is configured to hold the hatch in the closed position. The second vessel includes a stop configured to disable the hatch from moving beyond the closed position. The detent pair includes a detent element carried by the hatch and a complemental detent element carried by the stop. The first vessel includes a first sidewall and the second vessel includes a second sidewall. The second sidewall extends upright from the second bottom. The hatch configured to pivot between the closed position and the open position relative to the sidewall. The sidewall includes a sidewall hatchway extending upright from the second bottom, the hatch includes a secondary hatch configured to close the sidewall hatchway when the hatch is in the closed position and open the sidewall hatchway when the hatch is in the open position. The secondary hatch extends from the hatch to handle, and the handle extends outwardly through the sidewall hatchway beyond the sidewall when the hatch is in the closed position. A first abutment component is carried by the first vessel, a second abutment component is carried by the second vessel, and the first abutment component is configured to interact with the second abutment component to disable the second vessel from lowering toward the first bottom out of the operative position of the second bottom. The first sidewall extends upright from the first bottom to a first rim defining a first opening over the second bottom. The second sidewall extends upright from the second bottom to and beyond the first rim through the first opening to a second rim defining a second opening over the first opening and the second bottom. The first abutment component includes the first rim, and the second abutment includes abutments over the first rim. Engagement assemblies are each configured to hold one of the abutments to the rim. Each engagement assembly includes one of a male component and a female component carried by the rim and another one of the male component and the female component carried by one of the abutments. A longitudinal divider extends upwardly toward the second bottom from the first bottom. The divider includes opposed, outwardly-facing sloped surfaces for deflecting broken down litter outwardly to either side of the confined volume.

According to the invention, a litter vessel includes a vessel including a bottom for reception of broken down litter, the bottom configured with slots and a hatch. The slots are configured to disable unbroken down litter from falling downwardly therethrough from the vessel and enable broken down litter to fall downwardly therethrough from the vessel. The hatch is adjustable between a closed position closing a hatchway and an open position opening the hatchway. The hatch is coupled to the bottom hingedly to pivot between the closed position and the open position. The hatch is configured with at least one of the slots. The slots are parallel to each other. A detent pair is configured to hold the hatch in the closed position. The first vessel includes a stop configured to disable the hatch from moving beyond the closed position, and the detent pair includes a detent element carried by the hatch and a complemental detent element carried by the stop. The vessel further includes a sidewall extending upright from the bottom. The hatch configured to pivot between the closed position and the open position relative to the sidewall. The sidewall includes a sidewall hatchway extending upright from the bottom. The hatch includes a secondary hatch configured to close the sidewall hatchway when the hatch is in the closed position and open the sidewall hatchway when the hatch is in the open position. The secondary hatch extends from the hatch to handle, and the handle extends outwardly through the sidewall hatchway beyond the sidewall when the hatch is in the closed position.

### BRIEF DESCRIPTION OF THE DRAWINGS

Specific objects and advantages of the invention will become readily apparent to those skilled in the art from the following detailed description of illustrative embodiments thereof, taken in conjunction with the drawings in which:

FIG. 1 is a top perspective view of a litter vessel assembly constructed and arranged in accordance with the invention, the litter vessel assembly including a collection vessel for reception of broken down litter under a litter vessel for reception of unbroken down litter, the litter vessel including a sidewall and a bottom configured with slots and a hatch, the bottom shown separated from the sidewall;

FIG. 2 is a bottom perspective view of the embodiment of FIG. 1;

FIG. 3 is a section view taken along line 3-3 of FIG. 1;

FIG. 4 is perspective view of the litter vessel of FIG. 1 shown assembled, the sidewall extending upright from the bottom configured with the slots and the hatch;

FIG. 5 is a bottom perspective view of the embodiment of FIG. 4;

FIG. 6 is a section view taken along line 6-6 of FIG. 4;

FIG. 7 is a section view taken along line 7-7 of FIG. 4;

FIG. 8 is a view corresponding to FIG. 4 illustrating the hatch as it would appear open;

FIG. 9 is a section view taken along line 9-9 of FIG. 8;

FIG. 10 is a section view taken along line 10-10 of FIG. 8;

FIG. 11 is a perspective view of the litter vessel of FIG. 4 nested in the collection vessel first illustrated in FIG. 1;

FIG. 12 is a section view taken along line 12-12 of FIG. 11;

FIG. 13 is a section view taken along line 13-13 of FIG. 11;

FIG. 14 is a view like FIG. 11 illustrating litter deposited into the litter vessel and upon which an animal can eliminate its bodily waste, namely, feces and urine;

FIG. 15 is a section view taken along line 15-15 of FIG. 14;

FIG. 16 is a section view taken along line 16-16 of FIG. 14 and illustrating a deposition of urine and feces upon the litter;

FIG. 17 is a view corresponding to FIG. 18 illustrating broken down litter falling downwardly through the slots of the bottom of the litter vessel into a confined volume between the bottom of the litter vessel over a bottom of the collection vessel leaving behind unbroken down litter in the litter vessel;

FIG. 18 is a section view taken along line 18-18 of FIG. 17;

FIG. 19 is a view corresponding to FIG. 14 illustrating the hatch as it would appear open opening a hatchway to the confined volume formed between the bottom of the litter vessel over the bottom of the collection vessel according to FIG. 17 and the feces of FIGS. 16-18 shown being deposited into the confined volume through the open hatchway;

FIG. 20 is a section view taken along line 20-20 of FIG. 19;

FIG. 21 is a view corresponding to FIG. 20 illustrating the hatch as it would appear closed;

FIG. 22 is a section view taken along line 22-22 of FIG. 21;

FIG. 23 is a view corresponding to FIG. 22 illustrating the litter vessel withdrawn from the collection vessel

FIG. 24 is a perspective view a litter vessel nested in an upper collection vessel nested in a lower collection vessel;

FIG. 25 is a section view taken along line 25-25 of FIG. 24; and

FIG. 26 is a view similar to FIG. 15 illustrating an alternate embodiment of a litter vessel assembly.

### DETAILED DESCRIPTION

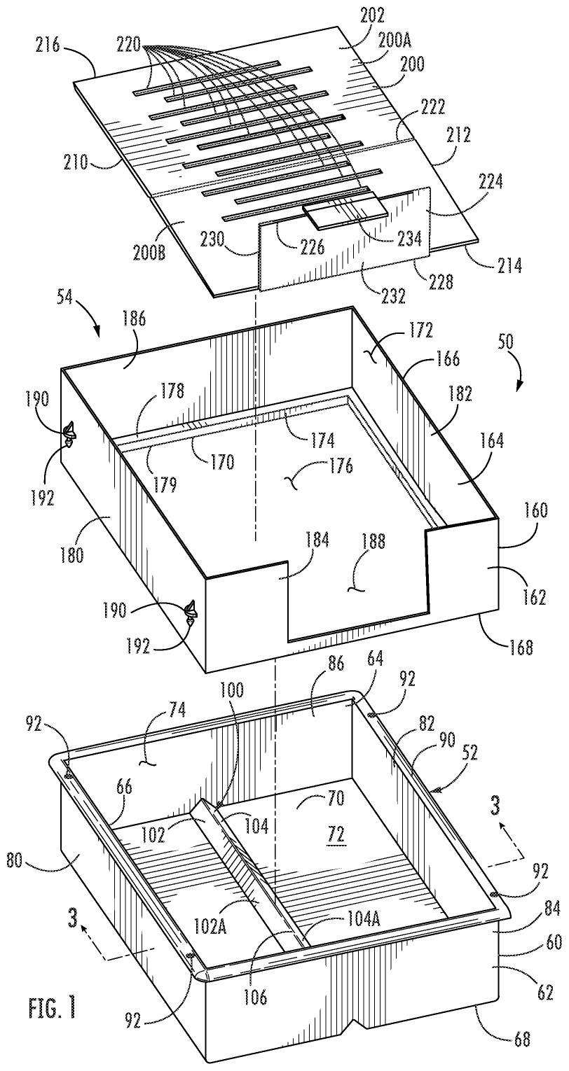

FIG. 1 illustrates a litter vessel assembly 50, including a collection vessel 52 appearing under a litter vessel 54. The litter vessel includes a sidewall 160 and a bottom 200 configured with slots 220 and a hatch 200B. FIG. 1 shows bottom 200 separated from sidewall 160. Litter vessel assembly 50 is an assemblage of collection vessel 52 and litter vessel 54. Collection vessel 52 and litter vessel 54 are configured to be nested together removably to form a confined volume between bottom 200 of litter vessel 54 and a floor or bottom 70 of collection vessel 52. Collection vessel 52 is the outer vessel and litter vessel 54 is the inner vessel. Bottom 200 of litter vessel 54 is for reception of unbroken down litter upon which an animal can eliminate its bodily waste, namely, feces and urine. Bottom 70 of collection vessel 52 is for reception of broken down litter from litter vessel 54. Slots 220, identical, elongate, narrow openings, are configured by being suitably sized and shaped to disable unbroken down litter from falling downwardly therethrough from litter vessel 54 into the confined volume and enable broken down litter to fall downwardly therethrough into the confined volume onto bottom 70 of collection vessel 52. Hatch 200B of bottom 200 of litter vessel 54 is adjustable between a closed position closing a hatchway to the confined volume and an open position opening the hatchway to the confined volume described in detail below. Litter vessel assembly 50 is portable, inexpensive, easy to use without specialized tools or expertise, and easy to clean.

### I. The Collection Vessel

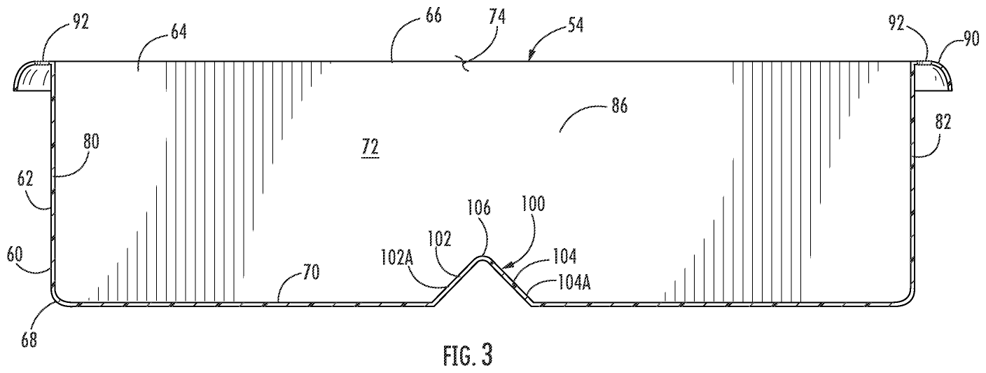

Referring to FIGS. 1-3 in relevant part, collection vessel 52 is a body useful as a container for receiving and holding broken down litter deposited therein from litter vessel 54 and is fluid impervious. Vessel 52 is preferably fashioned of plastic, an inexpensive and readily available material having inherently strong, rigid, resilient, and fluid impervious material characteristics. Vessel 52 includes sidewall 60 extending upright from bottom 70. Sidewall 60 is continuous and has outer surface 62, inner surface 64, upper edge or rim 66, and lower edge 68. Vessel 52 has a closed bottom defined by horizontal bottom 70 affixed to lower edge 68. Sidewall 60 extends between lower edge 68 affixed to bottom 70 and rim 66 at the opposed open end of vessel 52. Bottom 70 cooperates with inner surface 64 to form fluid impervious volume 72. Rim 66 is continuous and encircles opening 74 to volume 72 configured to receive contents placed therein and onto bottom 70 through opening 74 directly over bottom 70. Flange 90 configured with spaced apart openings 92 extends radially outward from rim 66. Flange 90 is part of or otherwise an extension of rim 66, follows rim 66, is continuous, and is rounded and curves downwardly from opening 74.

Sidewall 60 includes opposite side walls 80 and 82 that extend between opposite end walls 84 and 86. Side walls 80 and 82 at the respective sides of vessel 52 are equal in length and longer than equal in length end walls 84 and 86 at the respective ends of vessel 52. Vessel 52 is rectangular in overall shape in this example, in which side walls 80 and 82 are perpendicular relative to end walls 84 and 86, and the length of vessel 52 from end wall 84 to end wall 86 is greater than the width of vessel 52 from side wall 80 to side wall 82. Although vessel 52 is rectangular in this embodiment, it can be round, oval, square, triangular, or other chosen shape.

In this example, the length of flange 90 of rim 66 of side wall 80 extending between end wall 84 and end wall 86 has two openings 92, one at one end of side wall 80 near end wall 84 and another at the opposite end of side wall 80 near end wall 86. The length of flange 90 of rim 66 of side wall 82 extending between end wall 84 and end wall 86 also has two openings 92, one at one end of side wall 82 near end wall 84 and another at the opposite end of side wall 82 near end wall 86. Flange 90 of rim 66 defines abutment points or components proximate to the respective openings 92 each configured to interact with a corresponding abutment component of litter vessel 54 when litter vessel 54 is nested in collection vessel 52 described in detail below.

Vessel 52 additionally includes a divider 100. Divider 100 is elongate and straight, extends longitudinally along the length of vessel 52 from end wall 84 to end wall 86, parallel relative side walls 80 and 82, and perpendicular relative to end walls 84 and 86. Divider 100 is centered between and equally distanced from side walls 80 and 82. Divider 100 is triangular in cross-section and includes opposed walls 102 and 104 extending angularly upward from bottom 70 to a pointed crest or spine 106. Walls 102 and 104 have outwardly facing surfaces 102A and 104A, respectively. Surfaces 102A and 104A extend between bottom 70 and crest 106. Surface 102A between side walls 80 and 82 faces outwardly toward side wall 80, and slopes downwardly and away from crest 106 to bottom 70 in the direction of side wall 80. Surface 104A between side walls 80 and 82 faces outwardly toward side wall 82, and slopes downwardly and away from crest 106 to bottom 70 in the direction of side wall 82.

### II. The Litter Vessel

In FIG. 1, litter vessel 54 is a body useful as a container for receiving and holding unbroken down litter. Litter vessel 54 is configured to disable unbroken down litter from falling downwardly therethrough into collection vessel 52 and enable broken down litter to fall downwardly therethrough into collection vessel 52. Litter vessel 54 is an assembly of sidewall 160 and floor or bottom 200 each preferably fashioned of plastic, an inexpensive and readily available material having inherently strong, rigid, resilient, and fluid impervious material characteristics.

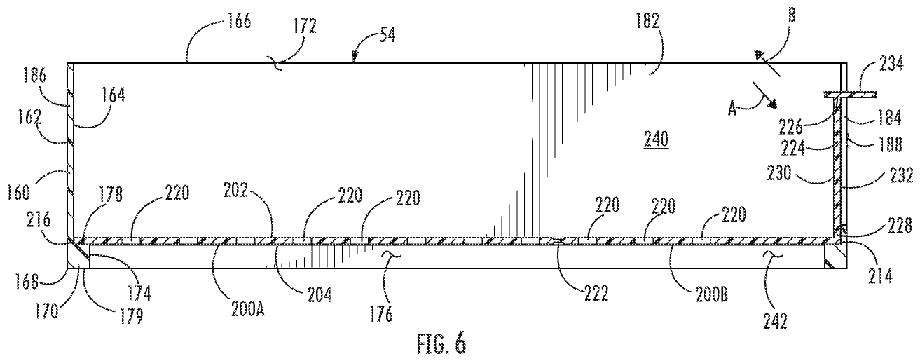

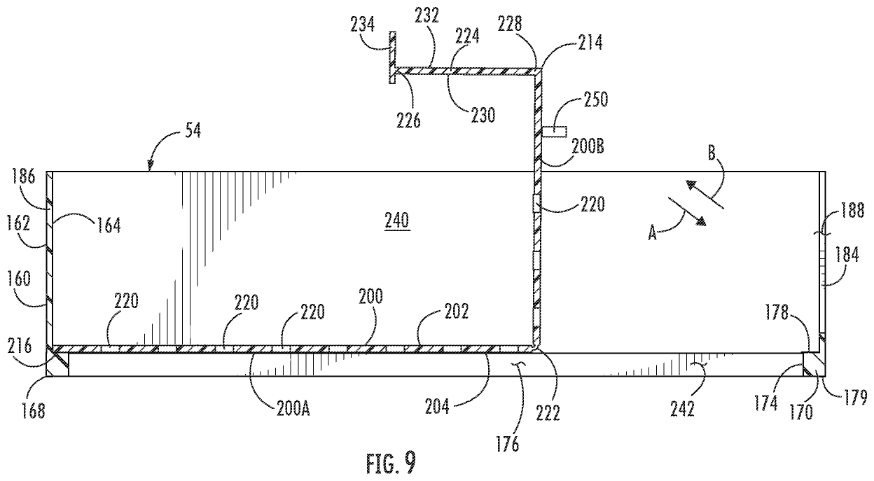

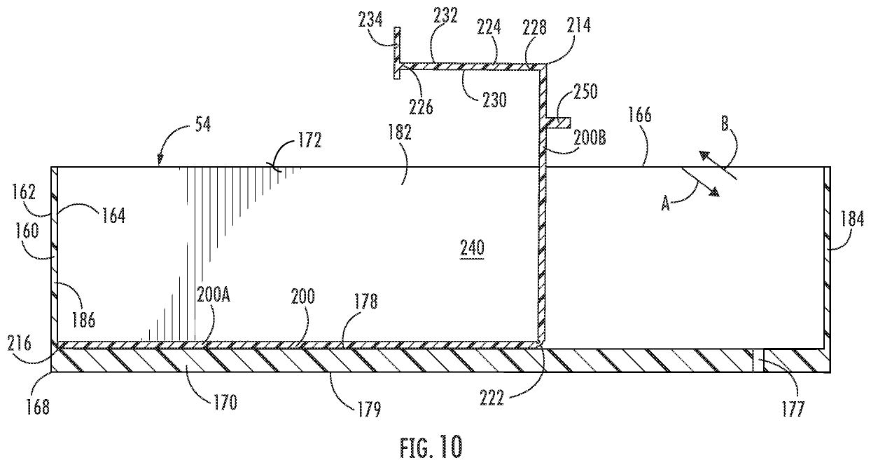

Referring in relevant part to FIGS. 1, 2, and 4-10, sidewall 160 is continuous and has outer surface 162, inner surface 164, upper edge or rim 166, lower edge 168, and flange 170. Sidewall 160 extends between lower edge 168 and rim 166. Rim 166 is continuous and encircles opening 172. Flange 170 is continuous, follows inner surface 164 and lower edge 168, extends inwardly from inner surface 164 and lower edge 168 to end surface 174 encircling opening 176, and extends vertically between horizontal upper and lower surfaces surface 178 and 179 extending inwardly from inner surface 164 to end surface 174. Opening 172 is the upper opening of sidewall 160. Opening 176 is under opening 172 and is the lower opening of sidewall 160. Openings 172 and 176 are coaxial.

Sidewall 160 includes opposite side walls 180 and 182 that extend between opposite end walls 184 and 186. Side walls 180 and 182 at the respective sides of sidewall 160 are equal in length and longer than equal in length end walls 184 and 186 at the respective ends of sidewall 160. Sidewall 160 is rectangular in overall shape in this example, in which side walls 180 and 182 are perpendicular relative to end walls 184 and 186, and the length of sidewall 160 from end wall 184 to end wall 186 is greater than the width of sidewall 160 from side wall 180 to side wall 182. Although sidewall 160 is rectangular in this embodiment, it can be round, oval, square, triangular, or other chosen shape commensurate with the selected shape of collection vessel 52.

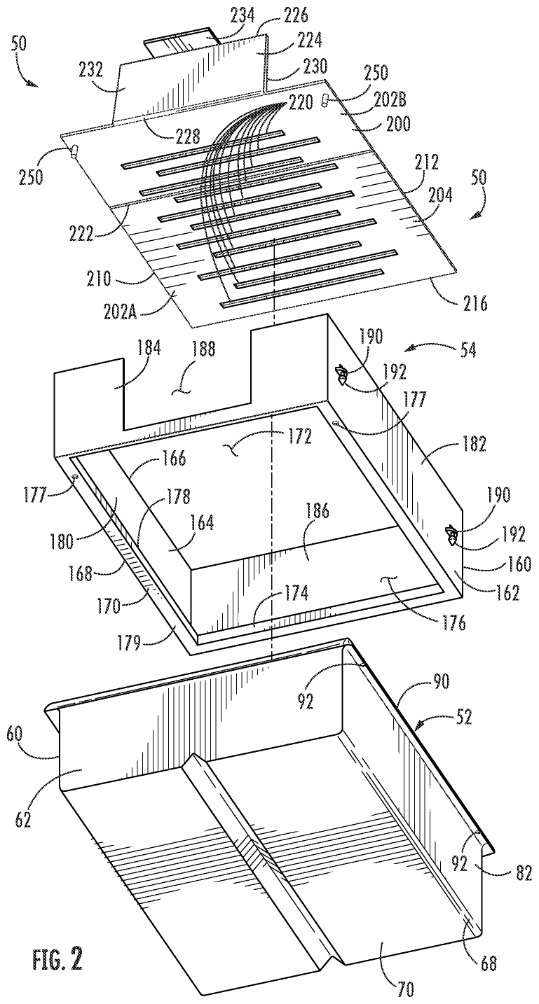

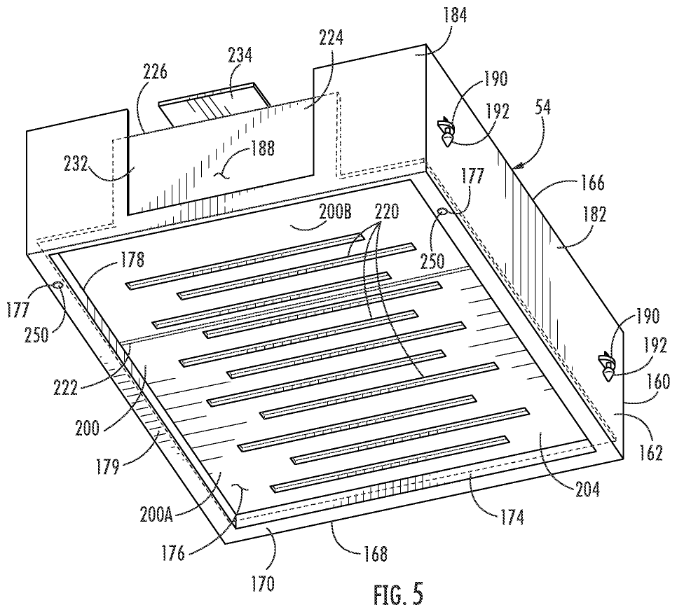

Flange 170 has openings 177 in FIGS. 2 and 5. Openings are identical and extend through flange 170 from upper surface 178 to lower surface 179. There are two openings 177, one that is near end wall 184 and that extends through the part of flange 170 extending along the length of side wall 180, and one that is near end wall 184 and that extends through the part of flange 170 extending along the length of side wall 182. Each opening 177 is part of a detent pair configured to interact between bottom 200 and flange 170 of sidewall 160 to hold a hatch of bottom 200 in its closed position described below.

End wall 184 includes a hatchway 188. Hatchway 188 extends through end wall 184 from outer surface 162 to inner surface 164, is generally rectangular, is centered between side walls 180 and 182, and extends into end wall 184 from rim 166 to just above lower edge 168.

Sidewall 160 supports spaced apart abutments 190. Abutments 190 positionally and numerically relate to openings 92 of collection vessel 52 and are identical in every respect. Each abutment 190 is affixed to and extends outwardly from outer surface 164 and supports a downwardly depending peg 192. Abutments 190 are between rim 166 and lower edge 168 and are distanced identically below rim 166 and above lower edge 168. Sidewall 180 has two abutments 190, one at one end of side wall 180 near end wall 184 between rim 166 and lower edge 168 and another at the opposite end of side wall 180 near end wall 186 between rim 166 and lower edge 168. Sidewall 182 has two abutments 190, one at one end of side wall 182 near end wall 184 between rim 166 and lower edge 168 and another at the opposite end of side wall 182 near end wall 186 between rim 166 and lower edge 168. Each abutment 190 is an abutment component of litter vessel 54 configured to interact with the corresponding abutment component of collection vessel 52 when litter vessel 54 is nested in collection vessel 52. Each abutment component of collection vessel 52 is the surface part(s) or point(s) of rim's 66 flange 90 that receives a corresponding abutment 190 there against when litter vessel 54 is nested in collection vessel 52. Each peg 192 and corresponding opening 92 constitute an engagement assembly configured, when assembled, to hold the corresponding abutment 190 to rim's 66 flange 90.

In FIGS. 1 and 2, bottom 200, a panel structure, includes upper surface, 202, lower surface 204, and perimeter extremity defined by opposite side edges 210 and 212 extending between opposite end edges 214 and 216. Side edges 210 and 212 are parallel to one another, end edges 214 and 216 are parallel to one another, and side edges 210 and 212 are perpendicular to end edges 214 and 216. Side edges 210 and 212 at the respective sides of bottom 200 are equal in length and longer than equal in length end edges 214 and 216 at the respective ends of bottom 200.

Slots 220 extend through bottom 200 from upper surface 202 to lower surface 204. Slots 220, narrow, elongate, unbroken openings, are parallel to one another, perpendicular to side edges 210 and 212, parallel to end edges 214 and 216, and spaced apart longitudinally along the length of bottom 200 from proximate to end edge 214 to proximate to end edge 216. Each slot 220 extends along substantially the entire width of bottom 200 from adjacent to side edge 214 to adjacent to side edge 216. In this example, slots 220 are alternately staggered.

Bottom 200 has a hinge 222. Hinge 222 divides bottom 200 into two flat panels, a stationary panel 200A extending from hinge 222 to end edge 216 and a movable panel 200B extending from hinge 222 to end edge 214. Stationary panel 200A is the stationary part of bottom 200. Movable panel 200B is the movable part of bottom 200. Movable panel 200B is the hatch of bottom 200 for a hatchway described below. Hinge 222 is perpendicular to side edges 210 and 212, parallel to end edges 214 and 216, extends from side edge 210 to side edge 212, and is between end edge 214 and end edge 216. Hinge 220 is closer to end edge 214 than to end edge 216, making stationary panel 200A somewhat larger than movable panel 200B. In this example, hinge 220 is a living hinge, a thin flexible hinge, i.e. a flexure bearing, made from the same material as stationary panel 200A and movable panel or hatch 200B it connects hingedly. Hinge 222 is typically thinned or cut to allow hatch 200B to bend along the line of hinge 220. The minimal friction and wear in hinge 220 are inherently useful and inexpensive in the design of bottom 200. Hatch 200B is easily and repeatedly pivoted by hand between an open position opening a hatchway and closed position closing the hatchway. The specifics are described below in detail. Movable panel 200B has three slots 220 in this example and can have more than three slots 220 and preferably no less than one slot 220.

Movable panel 200B has a secondary hatch 224 configured to open and close hatchway 188 through sidewall 160 in response to movement of movable panel 200B between its open and closed positions. Hatch 224 is centered between side edges 210 and 212 extends vertically upright relative to upper surface 202 to an upper edge 226 from a lower edge 228 affixed rigidly to end edge 214. Hatch 224 is a flat panel including opposed inner and outer surfaces 230 and 232. A handle 234 affixed to upper edge 226 extends inwardly from inner surface 230 and outwardly from outer surface 232. Movable panel 200B and its secondary hatch 224 are perpendicular relative to one another.

Movable panel 200B supports pegs 250 in FIG. 2. Pegs 250 are identical and positionally and numerically relate to openings 177 of flange 170. Each peg 250 is affixed to and extends downwardly from lower surface 204 of movable panel 200B. One peg 250 is adjacent to side edge 210 near end edge 214, and the other peg 250 is adjacent to side edge 212 near end edge 214. Openings 177 are configured to releasably receive and frictionally retain the respective pegs 250 to hold movable panel 200B in its closed position described below. Each peg 250 and corresponding opening 177 are a detent pair configured to interact between movable panel 200B and sidewall 160 to hold movable panel 200B in its closed position.

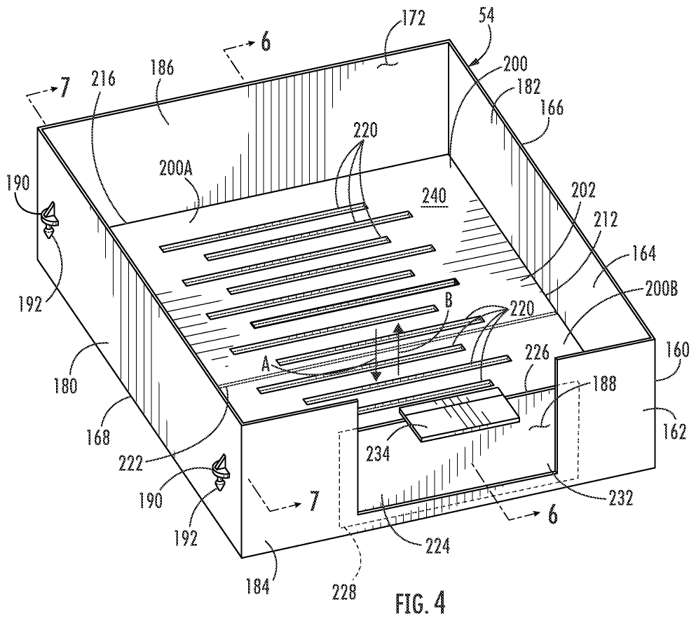

In FIGS. 4-7, the assembly of sidewall 160 and bottom 200 forms litter vessel 54. Referring to FIGS. 4-7 in relevant part, lower surface 204 inboard of the perimeter edge of bottom 200 sits directly atop upper surface 178 of flange 170. Flange 170 relates to and supports bottom 200 directly under upper opening 172 and directly over lower opening 176. Lower surface 204 extending inwardly from flange 170 faces and resides directly over and spans lower opening 176. Upper surface 202 extending inwardly from inner surface 164 of sidewall 160 faces and resides directly under upper opening 172. Sidewall 160 extends upright from upper surface 202 of bottom 200 to rim 166 encircling upper opening 172 directly over upper surface 202. Upper surface 202 of bottom 200 cooperates with inner surface 164 to form volume 240 of litter vessel 54. Volume 240 is configured to receive contents placed therein onto upper surface 202 of bottom 200 through upper opening 172. The perimeter of bottom 200 and inner surface 164 of sidewall 160 are juxtaposed. The perimeter of bottom 200 preferably abuts inner surface 164 of sidewall 160. Side edge 210 and inner surface 164 of side wall 180 are juxtaposed, side edge 212 and inner surface 164 of side wall 182 are juxtaposed, end edge 214 and inner surface 164 of end wall 184 are juxtaposed, and end edge 216 and inner surface 164 of end wall 186 are juxtaposed. Slots 220 are perpendicular to side walls 180 and 182, parallel to end walls 184 and 186, and spaced apart longitudinally along the length of bottom 200 from proximate to end wall 184 to proximate to end wall 186.

Stationary panel 200A extends along inner surface 164 of side walls 180 and 182 from end edge 216 at inner surface 164 of end wall 186 to hinge 222 between end walls 214 and 216. Movable panel 200B described here in its closed position coplanar with stationary panel 200A extends along inner surface 164 of side walls 180 and 182 from hinge 222 to end edge 214 and hatch 224 at inner surface 164 of end wall 184. Hinge 222 is perpendicular to side walls 180 and 182 and parallel to end walls 184 and 186. Lower surface 204 of movable panel 200B extends over a hatchway 242 over and to lower opening 176. Hatch 224 extends upright along inner surface 164 and hatchway 188 of end wall 184 from upper surface 202 of bottom 200 to upper edge 226 and handle 234 just below rim 166. Inner surface 230 faces volume 240 and outer surface 232 faces inner surface 164 of end wall 184 and hatchway 188. Outer surface 232 contacts inner surface 164 of end wall 184 on either side of and under hatchway 188. The remainder of outer surface 232 faces and extends upwardly along and longitudinally across hatchway 188, closing it to disable contents from spilling outwardly from volume 240 through hatchway 188 and enable access to hatchway 242 when it is open when movable panel 200B is open. Upper edge 226 of hatch 224 extending longitudinally across hatchway 188 resides just below rim 166 through which hatchway 188 extends. Handle 234 extends inwardly into volume 240 from inner surface 230 and outwardly from outer surface 232 through hatchway 188, enabling it to be easily gripped by hand. In an alternate embodiment, hatch 224 can be sized to extend upwardly at least to upper edge 166 of end wall 184, in which upper edge 226 of hatch 224 supporting the overlying handle 234 would reside at or above rim 166 through which hatchway 188 extends.

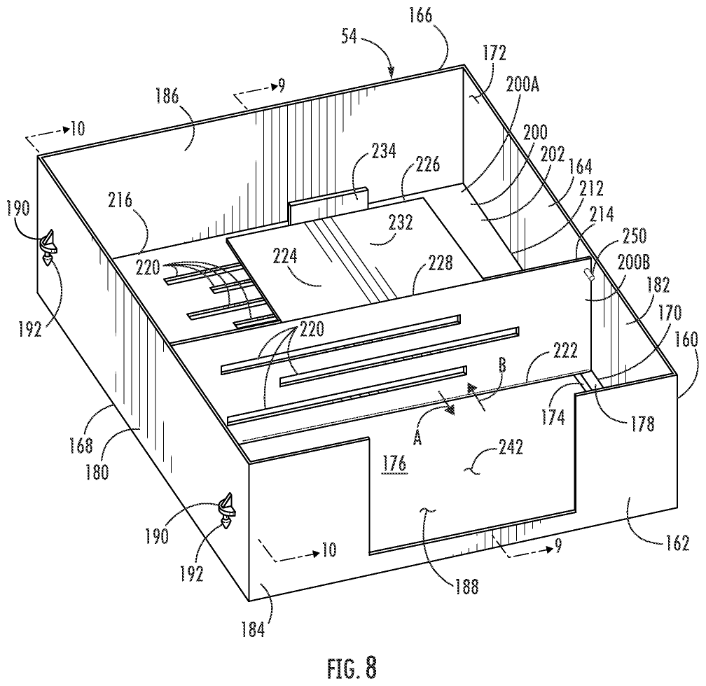

Lower surface 204 of stationary panel 200A is affixed rigidly to upper surface 178 of flange 170, such as by welding or a suitable adhesive in this example. Lower surface 204 of movable panel 200B is not rigidly affixed to upper surface 178 of flange 170. This enables movable panel 200B to pivot at hinge 222 in the direction of arrow A in FIGS. 4 and 6-10 into its lowered closed position in FIGS. 4-7 and in the direction of arrow B out of its closed position to its raised open position in FIGS. 8-10. When movable panel 200B is in its closed position in FIGS. 4-7, the lowered movable panel 200B rests on upper surface 178 of flange 170 and closes hatchway 242 to lower opening 176. At the same time, hatch 224 is against inner surface 164 of end wall 184 and closes hatchway 188 through end wall 184. When movable panel 200B is in its raised to its open position in FIGS. 8-10, the raised movable panel 200B extends upright through volume 240 to handle 234 from hinge 222 and movable panel 200B is withdrawn from upper surface 178 of flange 170 and hatch 242 opening it to lower opening 176. At the same time, hatch 224 is withdrawn from inner surface 164 of end wall 184 and hatchway 188 opening it. Upper surface 178 of flange 170 serves as a stop disabling movable panel 200B from pivoting at hinge 222 into hatchway 242 beyond its described closed position. Hatch 224 and hatchway 188 are comparably sized to enable hatch 224 to close hatchway 188 when movable panel 200B is in its lowered closed position.

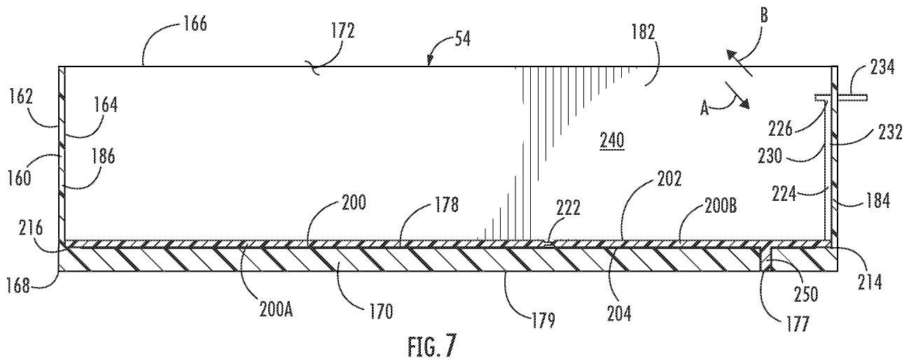

Openings 177 receive and frictionally retain the respective pegs 250 when movable panel 200B is in its closed position in FIGS. 5 and 7 holding or otherwise retaining movable panel 200B in its closed position releasably. Pegs 250 withdraw from their respective openings 177 when movable panel 200B is moved out of its closed position and remain withdrawn from the respective openings 188 when movable panel 200B is in its open position in FIGS. 8-10. Handle 234 is useful for moving movable panel 200B between its open and closed positions. To move movable panel 200B from its closed position to its open position, a user takes up handle 234 by hand and pulls it upwardly with force sufficient to withdraw or otherwise separate pegs 250 from their respective openings 177. To move movable panel 200B from its open position to its closed position, a user takes up handle 234 by hand and moves it downwardly with force sufficient to frictionally insert and engage pegs 250 into their respective openings 177.

Each peg 250 and its corresponding opening 177 define an element and a complementing element of a detent engagement pair or assembly. In each detent pair, flange 179 carries opening 177, a female element, and movable panel 200B carries peg 250, a male element. This arrangement is reversible.

### III. The Litter Vessel Assembly

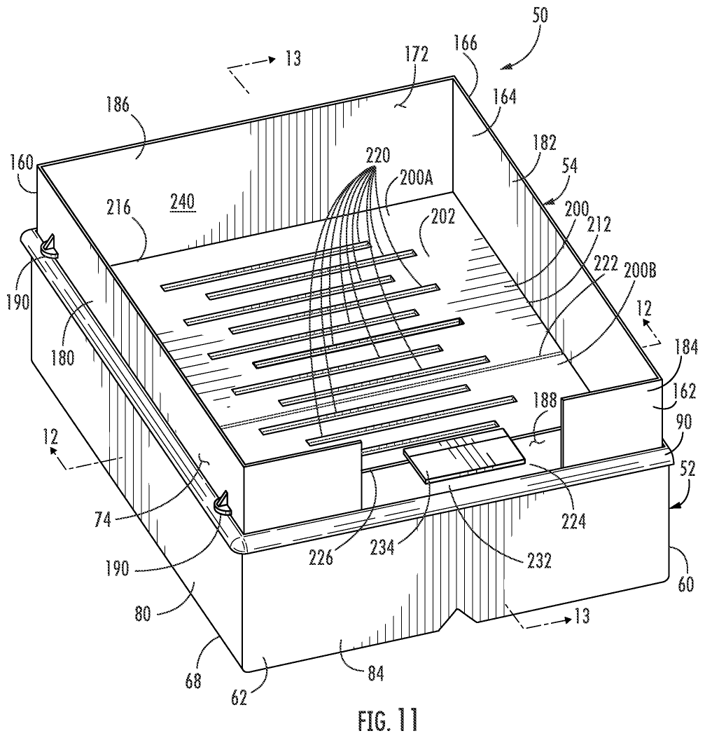

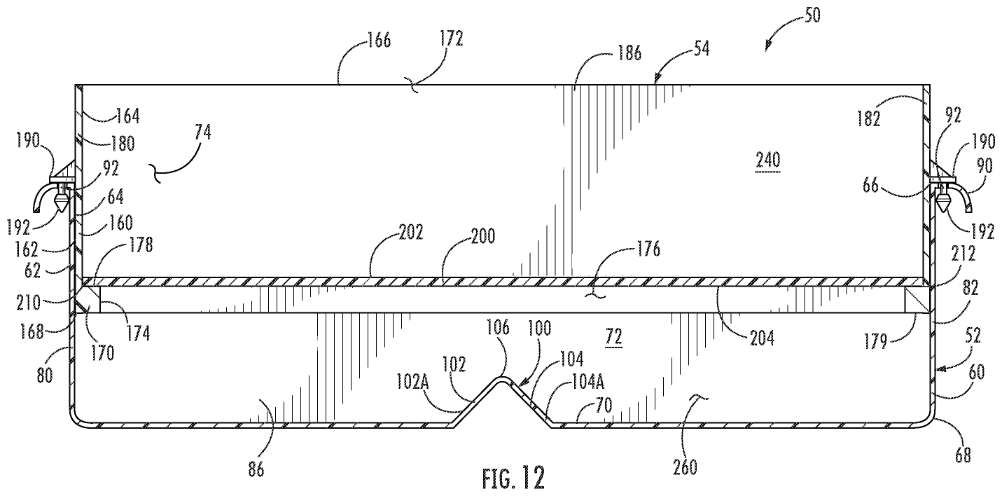

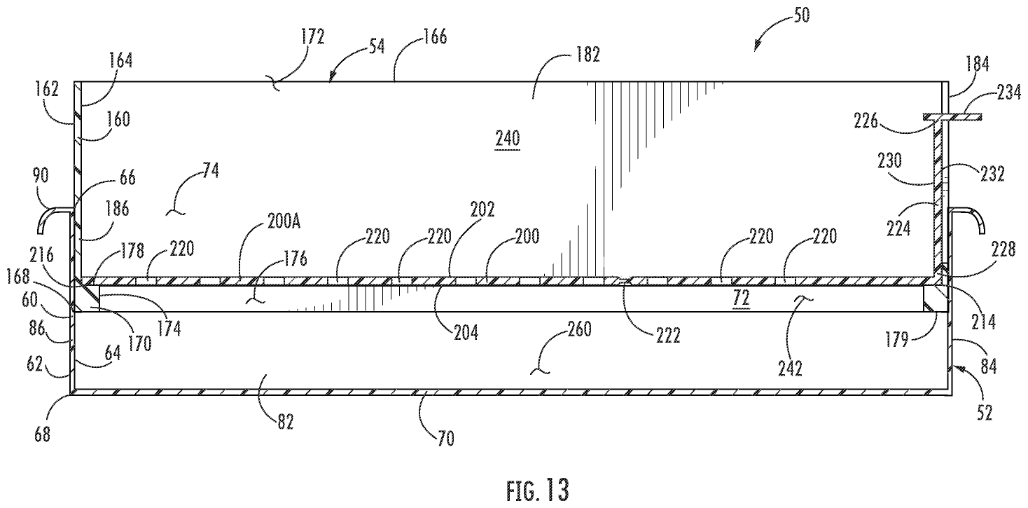

Litter vessel assembly 50 is an assembly of collection vessel 52 and litter vessel 54. Referring in relevant part to FIGS. 11-13, a user assembles collection vessel 52 and litter vessel 54 by supporting collection vessel 52 rim 66 up and bottom 200 down with its movable hatch 200B in its closed position, such as by placing collection vessel 52 bottom 70 down on the floor. Supported in this way, collection vessel 52 extends upright from bottom 70 to rim 66. She supports litter vessel 54 bottom 200 down over bottom 70 by first inserting pegs 192 into and through the respective openings 92 and then setting abutments 190 directly atop the registered abutment points of flange 90 proximate to the openings 92. To do this, she orients litter vessel 54 bottom 200 down rim 166 up over opening 74 being careful to axial align bottom 200 over opening 74 to register abutments 190 with the corresponding abutment points of flange 90 and pegs 192 with their respective openings 92. She then lowers litter vessel 54 flange 170 and bottom 200 first into volume 72 of collection vessel 52 through opening 74 and carefully inserts pegs 192 through their corresponding openings 92 and sets abutments 190 directly atop and against the registered abutment points of flange 90 proximate to the respective openings 92. The assembly of each peg 192 and its corresponding opening 92 releasably secures abutments 190 to flange 90 to releasably secure litter vessel 54 to collection vessel 52. Each peg 192 and corresponding opening 92 are an engagement assembly which, when assembled, holds a corresponding abutment 190 to rim 90. The direct engagement of abutments 190 against the corresponding abutment points of flange 90 suspends litter vessel 54 nested in volume 72 over bottom 70. Sidewall 60 of collection vessel 52 extends upright along outer surface 162 of sidewall 160 of litter vessel 54 from bottom 70 to rim 66, flange 90, pegs 192 inserted into their respective openings 92, abutments 190 atop flange 90, and opening 74 over bottom 200. Sidewall 160 of litter vessel 54 extends upright along inner surface 64 of sidewall 60 of collection vessel 52 through volume 72 from bottom 200 elevated at an operative position over bottom 70 to and beyond rim 66 and flange 90 and through opening 74 to rim 166 above rim 66 and flange 90 and opening 172 directly over opening 74 and bottom 200.

In the resulting assembly of collection vessel 52 and litter vessel 54, opening 172, opening 74, bottom 200, and bottom 70 are axially aligned. Opening 172 of litter vessel 54 is over opening 74 of collection vessel 52, and bottom 200 is directly under openings 172 and 74 and elevated at an operative position directly over bottom 70 of collection vessel 52. This releasably secures litter vessel 54 to collection vessel 52, and suspends litter vessel 54 at its operative nested in volume 72 over bottom 70 by the described interaction between pegs 192, openings 92, abutments 190, and flange 90. The direct engagement of abutments 190 against the corresponding abutment points of flange 90 not only suspends litter vessel 54 nested in volume 72 over bottom 70 at its operative position but also disables litter vessel 54 from lowering beyond and out of its operative position. Sidewall 60 extending upwardly from bottom 70 to bottom 200 set at its operative position elevated over bottom 70 forms confined volume 260 under bottom 200 that is sufficiently sized for reception of broken down litter. Confined volume 260 extends upright between bottoms 70 and 200.

Divider 100 extends longitudinally through confined volume 260 from end wall 84 to end wall 86 between bottom 70 of collection vessel 52 and the overlying bottom 200 of litter vessel 54. Divider 100 extends upright toward lower surface 204 of bottom 200 to crest 106 from bottom 70, is centered between side walls 80 and 82, and is directly under and perpendicular to each slot 220. Surface 102A faces outwardly from between side walls 80 and 82 toward side wall 80, and slopes downwardly and away from crest 106 to bottom 70 in the direction of side wall 80. Surface 104A faces outwardly from between side walls 80 and 82 toward side wall 82, and slopes downwardly and away from crest 106 to bottom 70 in the direction of side wall 82.

Movable panel 200B in its closed position over opening 176 and confined volume 260 closes hatchway 242 to opening 176 and confined volume 260. Side walls 80 and 180 are juxtaposed, side walls 82 and 182 are juxtaposed, end walls 84 and 184 are juxtaposed, and end walls 86 and 186 are juxtaposed. Hatch 224 extends upright along inner surface 164 and hatchway 188 of end wall 184 from upper surface 202 of bottom 200 to upper edge 226 and handle 234. In this embodiment, handle 234 is just below rim 166 and just over rim 66 and its flange 90. Again, secondary hatch 224 can be sized to extend upwardly at least to upper edge 166 of end wall 184, in which upper edge 226 of hatch 224 supporting the overlying handle 234 would reside at or above rim 166 through which hatchway 188 extends. Inner surface 230 faces volume 240 between opening 172 and bottom 200 and outer surface 232 faces inner surface 164 of end wall 184 and hatchway 188 closing it as described above to disable contents from spilling outwardly from volume 240 through hatchway 188 and enable access to hatchway 242 when it is open when movable panel 200B is open. Upper edge 226 of hatch 224 extending longitudinally across hatchway 188 resides just below rim 166 through which hatchway 188 extends and just over rim 66 and its flange 90. Handle 234 under rim 166 and over rim 66 and its flange 90 extends inwardly into volume 240 from inner surface 230 and outwardly from outer surface 232 through hatchway 188 and outwardly from outer surface 62 of end wall 84, enabling it to be easily gripped by hand. The user need only reverse the above operation to withdraw and separate litter vessel 54 from collection vessel 52.

The abutment components of litter vessel 54 are abutments 190. The abutment components of collection vessel 52 are the surface part(s) or point(s) of rim's 66 flange 90 positioned to receive the respective abutments 190 there against when litter vessel 54 is nested in collection vessel 52. The described interaction between the abutment components of litter vessel 54 and the abutment components of collection vessel 52 sets bottom 200 at its operative position elevated or otherwise raised over bottom 70 and disables litter vessel 54 from lowering toward bottom 70 out of bottom's 200 operative position. Each abutment component of collection vessel 52 and corresponding abutment component of litter vessel 54 is an abutment pair that when assembled define an abutment assembly. Any suitable number of abutment assemblies is useful. The abutments assemblies are located exteriorly of outer surface 162 between collection vessel 52 and litter vessel 54. Suitable abutment assemblies configured to interact between collection vessel 52 and litter vessel 54 to set bottom 200 at its operative position elevated over bottom 70 to form confined volume 260 and disable litter vessel 54 from lowering toward bottom 70 out of the operative position of bottom 200 can be located between outer surface 162 of sidewall 160 and inner surface 64 of sidewall 60, between flange 170 and inner surface 64 of sidewall 60, or elsewhere.

Each peg 192 and corresponding opening 92 constitute an engagement pair that, when assembled, define an engagement assembly that holds the corresponding abutment 190 to rim's 66 flange 90 to detachably engage litter vessel 54 to collection vessel 52. In each engagement assembly, the positioning of each peg 192 and its corresponding opening 177 can be reversed. Any suitable number of engagement assemblies can be used.

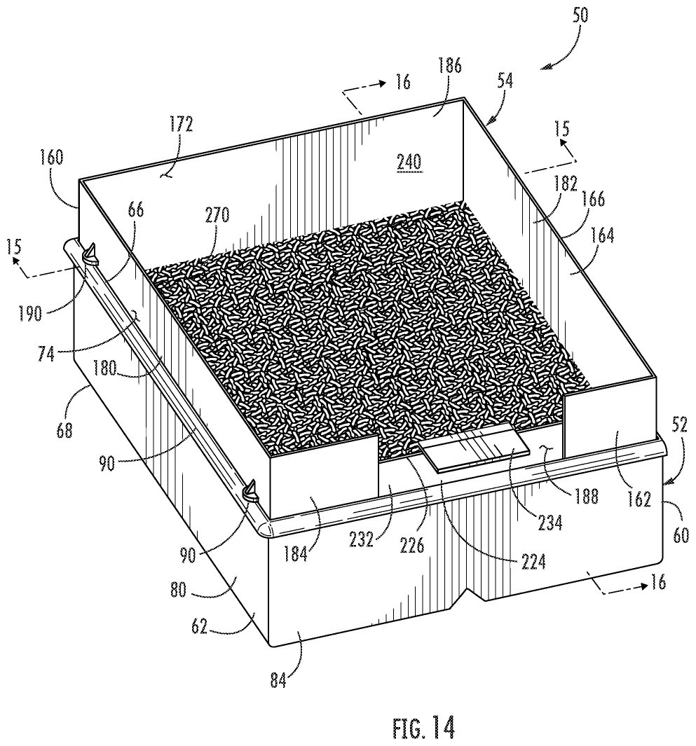

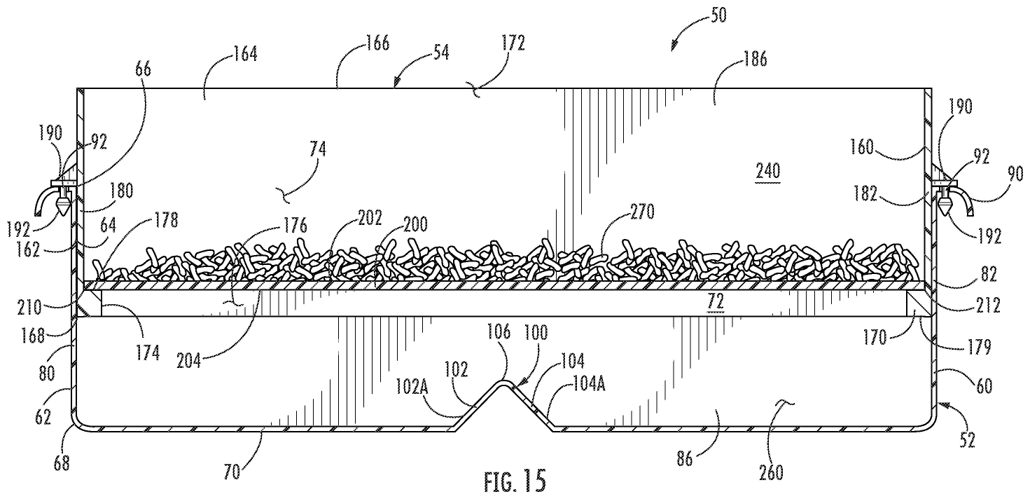

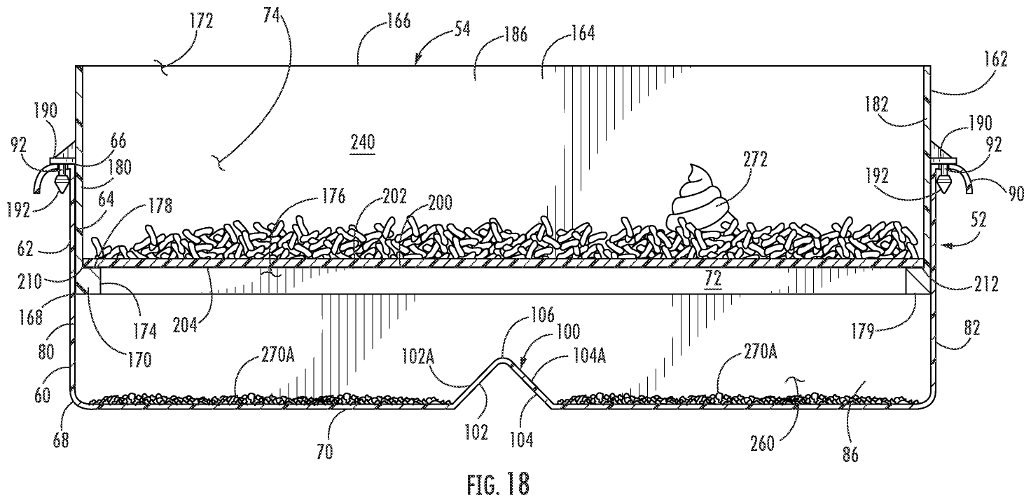

In FIGS. 14 and 15, the user deposits a charge of a standard and readily available loose pellet litter 270 into volume 240 of litter vessel 54 and spreads it out into a relatively even layer over upper surface 202 of bottom 200 and upon which an animal can eliminate its bodily waste, namely, feces 272 and urine 274. Each of the pellets 270 of the pellet litter 270 has a size and shape. The pellets 270 are substantially equal in size and shape according to standard and readily available pellet litter 270. Litter 270 wettened, especially by urine 274, automatically breaks down into fine particles/powder 270A. Any pellets 270 not wettened remain intact. Slots 220 are suitably sized and shaped in relation to the size of shape of each of the pellets 270 to disable unbroken down litter 270 from falling downwardly therethrough into confined volume 260 from volume 240 of litter vessel 54 and enable broken down litter 270A to fall downwardly therethrough into confined volume 260 and upon bottom 70 from volume 240 of litter vessel 54 leaving behind unbroken down litter 270 in litter vessel 54. Slots 220, including those of movable panel 200B, not only disable unbroken down litter 270 from falling into confined volume 260 from litter vessel 54 and enable broken down litter 270A to fall into confined volume 260 from litter vessel 54, they also resist clogging by the broken down litter 270A. FIG. 18 illustrates a mass of broken down litter 270A in contained in confined volume 260 over bottom 70. Outwardly-facing sloped surfaces 102A and 104A of divider 100 serve to deflect falling broken down litter 270A outwardly to either side of confined volume 260.

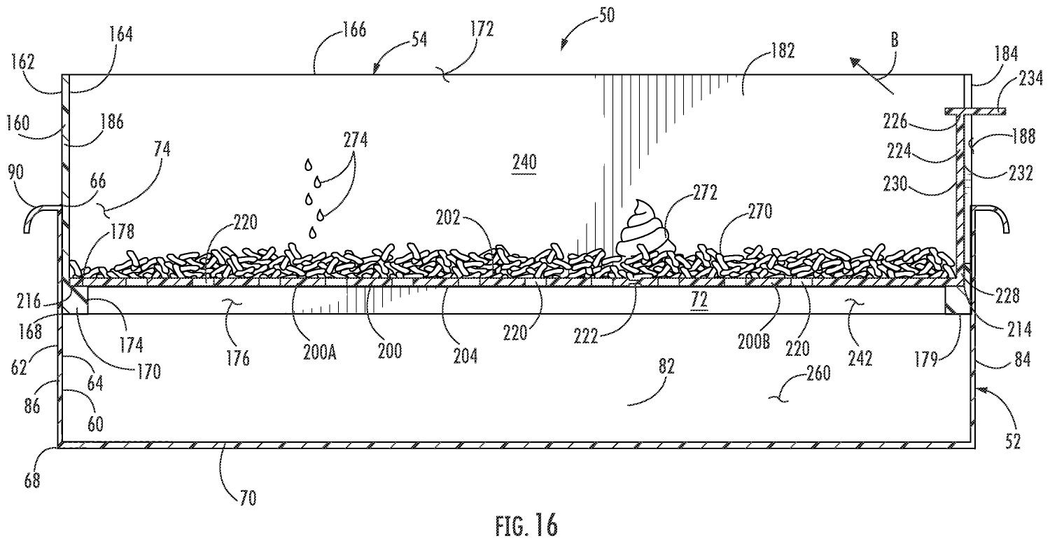

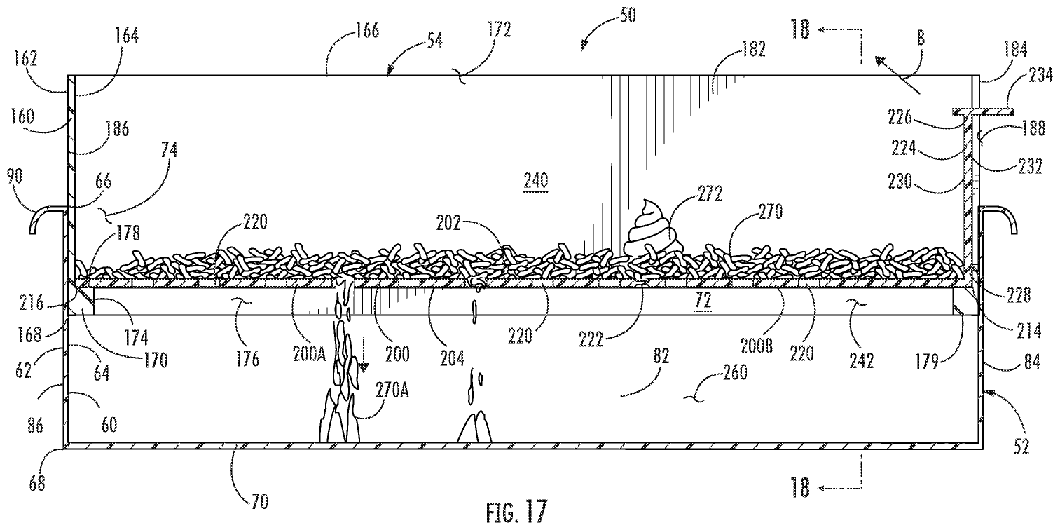

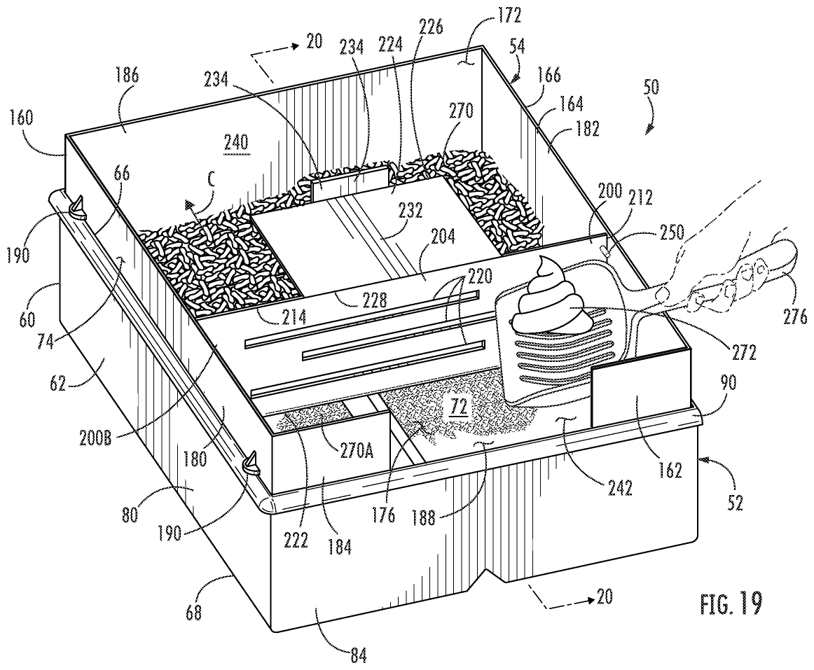

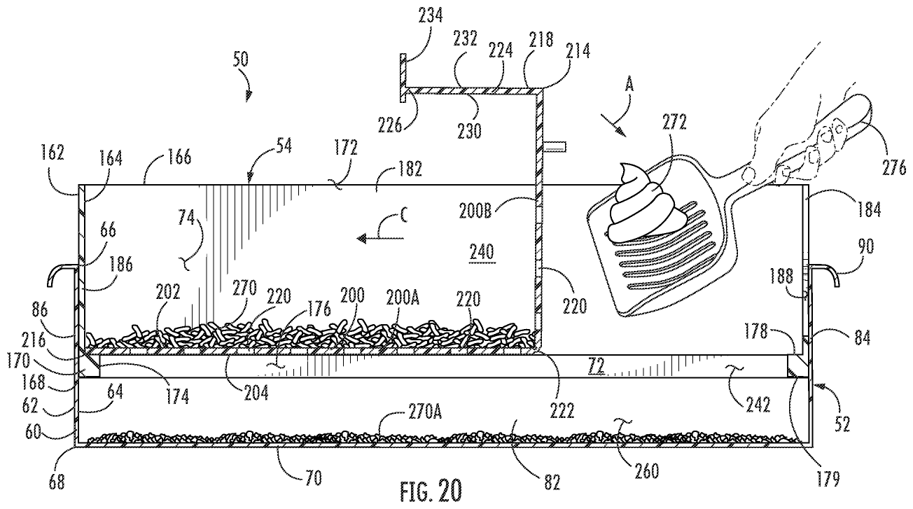

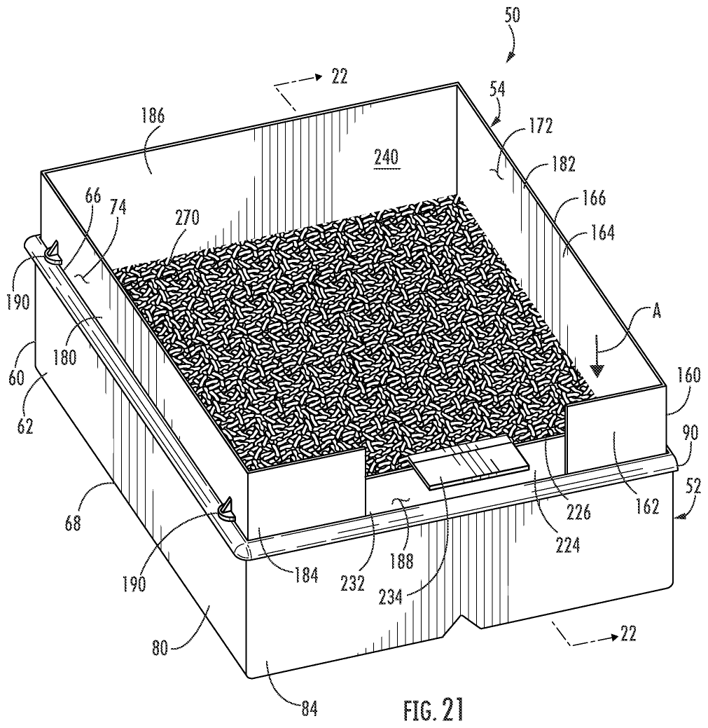

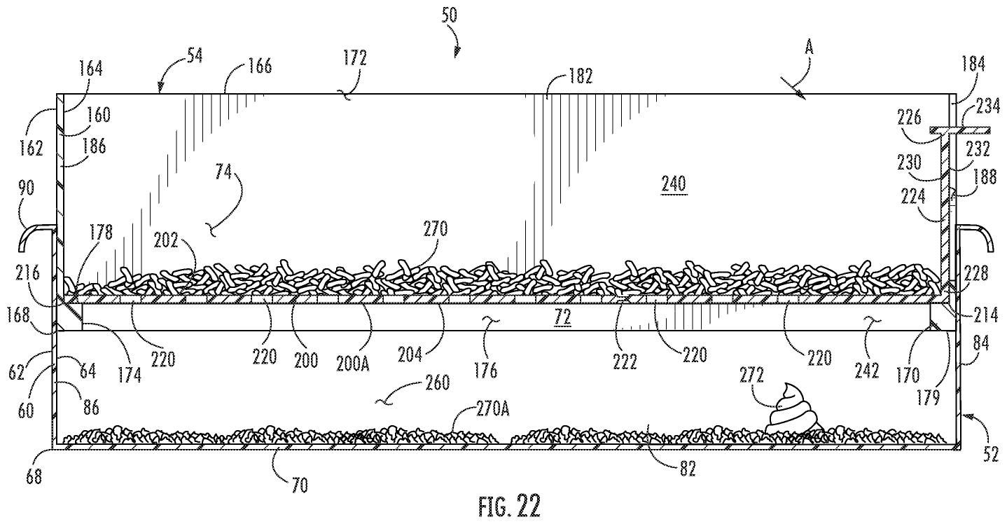

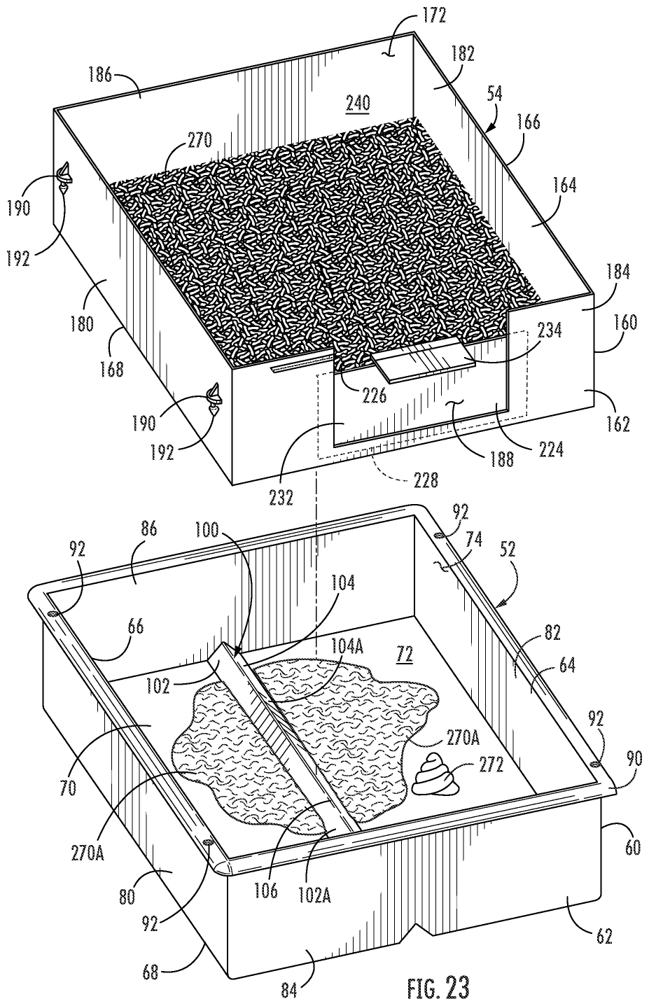

Litter vessel assembly 50 is configured to enable a user to transfer feces 272 in FIGS. 16-18 from atop litter 270 in volume 240 of litter vessel 54 to confined volume 260. A user does this by taking up handle 234 by hand and pulling it upwardly the direction of arrow B in FIGS. 16 and 17 to pivot movable panel 200B at hinge 222 out of its closed position in FIGS. 16 and 17 concurrently closing hatchways 242 and 188 to its open position in FIGS. 19 and 20 concurrently opening hatchway 242 to opening 176 to confined volume 260 and opening hatchway 188 extending upwardly to rim 166 from rim 66 and flange 90. When a user moves panel 200B moves out of its closed position to its open position, it forces any litter 270 over upper surface 202 of movable panel 200B between the inner surface 164 of side walls 180 and 182 in the direction of arrow C away from the now open hatchway 188 in FIGS. 19 and 20. The open hatchway 188 through end wall 184 extending upwardly to rim 166 from rim 66 and flange 90 enables access therethrough as needed to enable the user to transfer feces 272 into confined volume 260 through open hatchway 242. In FIGS. 19 and 20, the user picks up feces 272 from atop litter 270 in volume 240, such as with a handled implement 276, places it into confined volume 260 and onto bottom 70 through the now open hatchway 242, and recloses hatchways 242 and 188 by pivoting movable panel 200B in the direction of arrow A in FIGS. 20-22 out of its open position back into its closed position in FIGS. 21 and 22 confining feces 272 deposited in confined volume 260 in FIG. 22. A user may redistribute litter 270 over bottom 200 as needed. A user may repeat this process and replenish litter 270 or replace it with fresh litter as needed. A user cleans collection vessel 52 of any deposited broken down litter 270A and feces 272 by simply withdrawing litter vessel 54 from collection vessel 52 in FIG. 23, suitably cleaning bottom 70 of the deposited broken down litter 270A and feces 272, and reassembling litter vessel 54 and collection vessel 52 for continued use. The user repeats this process as needed.

A user may line the bottom 70 and inner surface 64 of sidewall 60 of collection vessel 52 with a suitable disposable liner, such as a standard and readily available garbage bag liner or a special purpose liner. The liner lining collection vessel 52 collects broken down litter from litter vessel 54. She cleans litter vessel assembly 50 by withdrawing litter vessel 54 from the lined collection vessel 52. She removes the used liner and its contents from collection vessel 52 and throws it away. She relines collection vessel 52 with a fresh liner and nests litter vessel 54 back into the freshly lined collection vessel 52 for continued use of the litter vessel assembly 50. She repeats this process as needed.

Each peg 250 and corresponding 177 is as a detent pair that when assembled define a detent assembly configured to hold movable panel 200B, the hatch of bottom 200 of litter vessel 54, in its closed position. The described detent pair has no moving parts, is efficient, simple structurally, and inexpensive. Other detent pair forms configured to temporarily keep movable panel 200B in its closed position relative to sidewall 160 and that can be released by applying force to one of the parts can be used and selectively positioned between bottom 200 and sidewall 160 in alternate embodiments, such as snap-type detent pairs, strike and protuberant detent pairs, and the like. Although litter vessel assembly 50 has two such detent pairs, it can incorporate just one or more the two of them.

Those having regard for the art will readily appreciate that an exemplary litter vessel assembly 50 is disclosed. Litter vessel assembly 50 is inexpensive, simple in construction, and easy to use and clean.

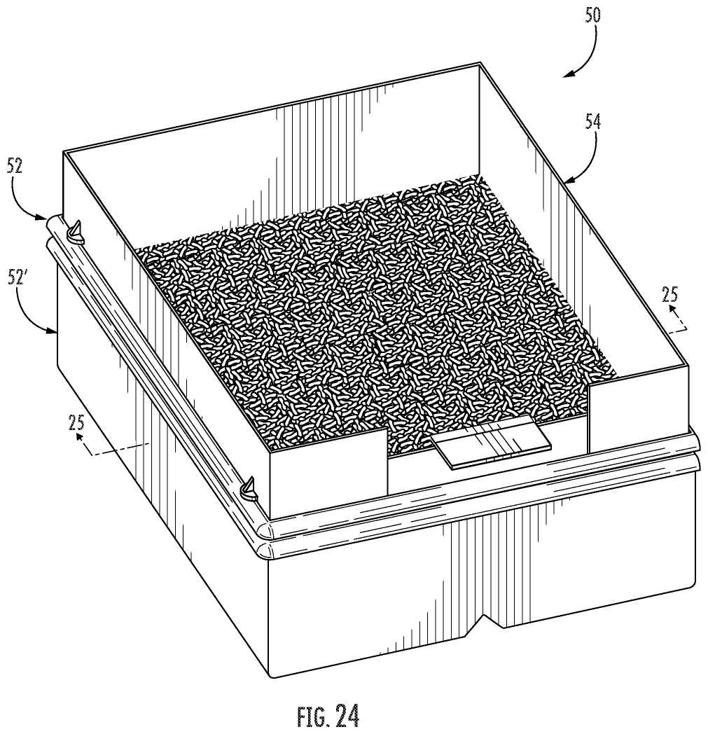

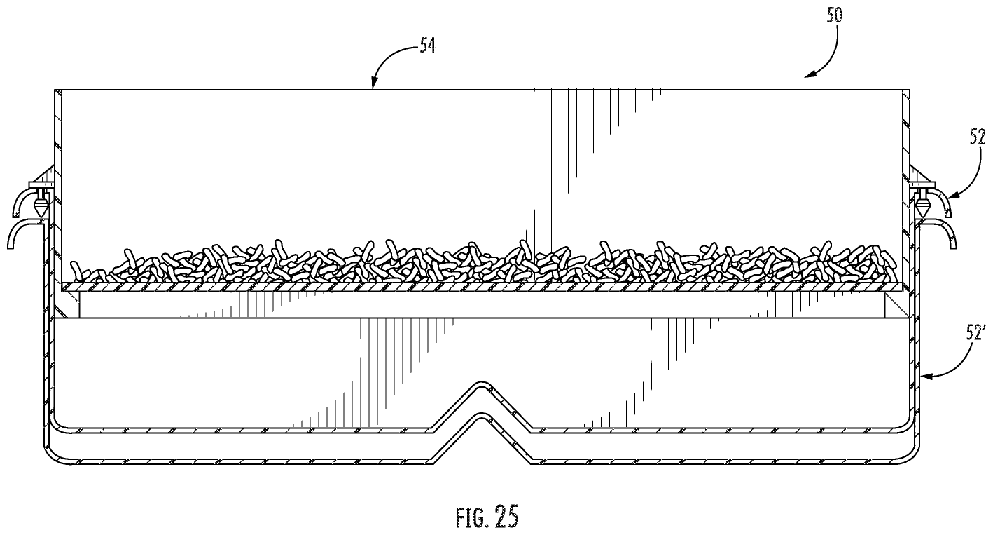

In FIGS. 24 and 25, identical collection vessels 52 and 52′ are nestable, one within the other. In FIGS. 24 and 25, collection vessel 52 with litter vessel 54 nested therein is shown nested into a clean lower collection vessel 52′ forming an assembly of litter vessel 54 and two nested collection vessels 52 and 52′. To clean and maintain this configuration, a user may separate litter vessel assembly 50 from collection vessel 52′, separate litter vessel 54 from collection vessel 52, and nest the removed litter vessel 54 into the clean collection vessel 52′ to form a litter vessel assembly according to the invention. The user may then clean and store the separated collection vessel 52 until needed or nest collection vessel 52′ with litter vessel 54 nested therein into collection vessel 52. A user may repeat this process as needed.

A user may line the collection vessels 52 and 52′ with suitable disposable liners, respectively, such as standard and readily available garbage bag liners or special purpose liners. Collection vessel's 52 liner collects broken down litter from litter vessel 54. She cleans the litter vessel system by removing the nested litter and collection vessels 54 and 52 from the lined collection vessel 52′. She separates litter vessel 54 from the lined collection vessel 52 and nests litter vessel 54 into the already lined collection vessel 52′ to form a “fresh” litter vessel assembly ready for immediate use. She removes the used liner and its contents from collection vessel 52 and throws it away. She relines collection vessel 52 with a fresh liner and nests collection vessel 52′ with litter vessel 54 nested therein into the freshly lined collection vessel 52 for continued use of the litter vessel system. She repeats this process as needed.

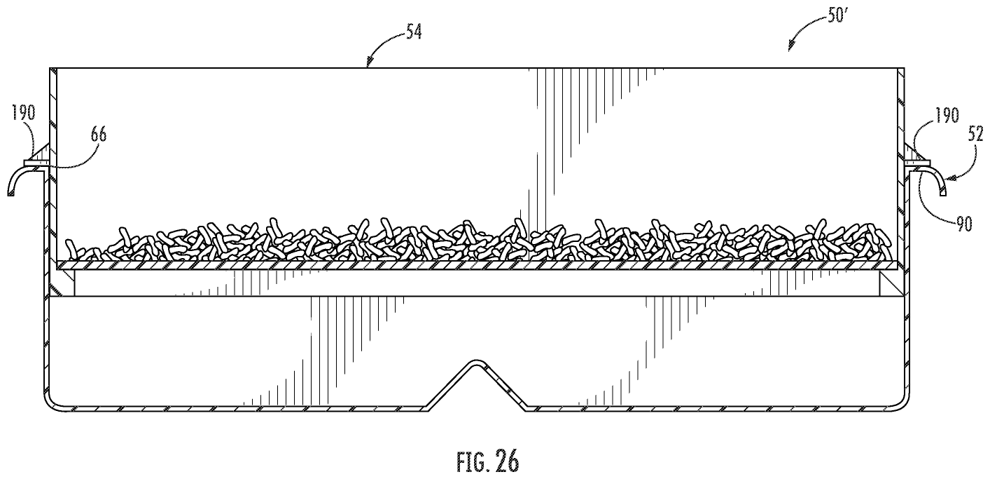

As disclosed, each peg 192 and corresponding opening 92 constitute an engagement pair that when assembled define an engagement assembly that holds the corresponding abutment 190 to rim's 66 flange 90 for detachably engaging litter vessel 54 to collection vessel 52. Pegs 192 and openings 92 are optional and can be eliminated as shown by the embodiment of a litter vessel assembly 50′ in FIG. 26 including litter vessel 54 nested in collection vessel 52 like the illustration of litter vessel assembly 50 in FIG. 15. Lacking liter vessel assembly's 50 pegs 192 and openings 92, in litter vessel assembly 50′ the simple interaction between litter vessel's 54 abutment components, abutments 190, and collection vessel's 52 abutment components, the surface part(s) or point(s) of rim's 66 flange 90 positioned to receive the respective abutments 190 there against when litter vessel 54 is nested in collection vessel 52, sets litter vessel 54 at its operative position relative to collection vessel 52. In FIG. 26, only two peg and opening pairs are absent, with the understanding that the other pairs are removed as well in this embodiment of litter vessel assembly 50′. It is to be understood that collection vessel 52 of the configuration in FIG. 26 can be nested in another collection vessel 52 as described above in conjunction with FIGS. 24 and 25.

### IV. CONCLUSION

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

1. A litter vessel assembly, comprising:
a vessel including a bottom for reception of broken down litter, the bottom positioned over a confined volume and configured with slots and a hatch;
the slots configured to disable unbroken down litter from falling downwardly therethrough into the confined volume from the vessel and enable broken down litter to fall downwardly therethrough into the confined volume from the vessel; and
the hatch adjustable between a closed position closing a hatchway to the confined volume and an open position opening the hatchway to the confined volume.

2. The litter vessel assembly according to claim 1, wherein the hatch is a movable part of the bottom and is hinged to pivot between the closed position and the open position relative to a stationary part of the bottom.

3. The litter vessel assembly according to claim 1, wherein the hatch is configured with at least one of the slots.

4. The litter vessel assembly according to claim 3, wherein the slots are parallel to each other.

5. The litter vessel assembly according to claim 1, further comprising a detent pair configured to hold the hatch in the closed position.

6. The litter vessel assembly according to claim 5, further comprising:
the vessel including a stop configured to disable the hatch from moving beyond the closed position; and
the detent pair including a detent element carried by the hatch and a complemental detent element carried by the stop.

7. The litter vessel assembly according to claim 1, the vessel further comprising a sidewall extending upright from the bottom, the hatch configured to pivot between the closed position and the open position relative to the sidewall.

8. The litter vessel assembly according to claim 7, further comprising:
the sidewall including a sidewall hatchway extending upright from the bottom; and
the hatch includes a secondary hatch configured to close the sidewall hatchway when the hatch is in the closed position and open the sidewall hatchway when the hatch is in the open position.

9. The litter vessel assembly according to claim 8, wherein:
the secondary hatch extends from the hatch to handle; and
the handle extends outwardly through the sidewall hatchway beyond the sidewall when the hatch is in the closed position.

10. A litter vessel assembly, comprising:
a first vessel including a first bottom for reception of broken down litter;
a second vessel including a second bottom for reception of unbroken down litter and configured with slots and a hatch;
the second vessel nested in the first vessel;
the second bottom elevated at an operative position over the first bottom to form a confined volume between the second bottom and the first bottom;
the slots configured to disable unbroken down litter from falling downwardly therethrough into the confined volume from the second vessel and enable broken down litter to fall downwardly therethrough into the confined volume from the second vessel; and
the hatch adjustable between a closed position closing a hatchway to the confined volume and an open position opening the hatchway to the confined volume.

11. The litter vessel assembly according to claim 10, wherein the hatch is a movable part of the second bottom and is hinged to pivot between the closed position and the open position relative to a stationary part of the second bottom.

12. The litter vessel assembly according to claim 10, wherein the hatch is configured with at least one of the slots.

13. the litter vessel assembly according to claim 12, wherein the slots are parallel to each other.

14. The litter vessel assembly according to claim 10, further comprising a detent pair configured to hold the hatch in the closed position.

15. The litter vessel assembly according to claim 14, further comprising:
the second vessel including a stop configured to disable the hatch from moving beyond the closed position; and
the detent pair including a detent element carried by the hatch and a complemental detent element carried by the stop.

16. The litter vessel assembly according to claim 10, the second vessel further comprising a sidewall extending upright from the second bottom, the hatch configured to pivot between the closed position and the open position relative to the sidewall.

17. The litter vessel assembly according to claim 16, further comprising:
the sidewall including a sidewall hatchway extending upright from the second bottom; and
the hatch includes a secondary hatch configured to close the sidewall hatchway when the hatch is in the closed position and open the sidewall hatchway when the hatch is in the open position.

18. The litter vessel assembly according to claim 17, wherein:
the secondary hatch extends from the hatch to handle; and
the handle extends outwardly through the sidewall hatchway beyond the sidewall when the hatch is in the closed position.

19. The litter vessel assembly according to claim 10, further comprising:
a first abutment component carried by the first vessel;
a second abutment component carried by the second vessel; and
the first abutment component configured to interact with the second abutment component to disable the second vessel from lowering toward the first bottom out of the operative position of the second bottom.

20. The litter vessel assembly according to claim 19, wherein:
the first vessel includes a first sidewall extending upright from the first bottom to a first rim defining a first opening over the second bottom;
the second vessel includes a second sidewall extending upright from the second bottom to and beyond the first rim through the first opening to a second rim defining a second opening over the first opening and the second bottom;
the first abutment component comprises the first rim; and
the second abutment component comprises abutments over the first rim.

21. The litter vessel assembly according to claim 20, further comprising a plurality of engagement assemblies each configured to hold one of said abutments to the rim.

22. The litter vessel assembly according to claim 21, wherein each said engagement assembly includes one of a male component and a female component carried by the rim and another one of the male component and the female component carried by one of the abutments.

23. The litter vessel assembly according to claim 10, further comprising a longitudinal divider extending upwardly toward the second bottom from the first bottom, the divider including opposed, outwardly-facing sloped surfaces for deflecting broken down litter outwardly to either side of the confined volume.

24. A litter vessel, comprising:
a vessel including a bottom for reception of broken down litter, the bottom configured with slots and a hatch;
the slots configured to disable unbroken down litter from falling downwardly therethrough from the vessel and enable broken down litter to fall downwardly therethrough from the vessel; and
the hatch adjustable between a closed position closing a hatchway and an open position opening the hatchway.

25. The litter vessel according to claim 24, wherein the hatch is coupled to the bottom hingedly to pivot between the closed position and the open position.

26. The litter vessel according to claim 34, wherein the hatch is configured with at least one of the slots.

27. The litter vessel according to claim 6, wherein the slots are parallel to each other.

28. The litter vessel according to claim 24, further comprising a detent pair configured to hold the hatch in the closed position.

29. The litter vessel according to claim 28, further comprising:
the first vessel including a stop configured to disable the hatch from moving beyond the closed position; and
the detent pair including a detent element carried by the hatch and a complemental detent element carried by the stop.

30. The litter vessel according to claim 24, the vessel further comprising a sidewall extending upright from the bottom, the hatch configured to pivot between the closed position and the open position relative to the sidewall.

31. The litter vessel according to claim 30, further comprising:
the sidewall including a sidewall hatchway extending upright from the bottom; and
the hatch includes a secondary hatch configured to close the sidewall hatchway when the hatch is in the closed position and open the sidewall hatchway when the hatch is in the open position.

32. The litter vessel according to claim 31, wherein:
the secondary hatch extends from the hatch to handle; and
the handle extends outwardly through the sidewall hatchway beyond the sidewall when the hatch is in the closed position.
